(19) United States
(12) Patent Application Publication
(10) Pub. No.: US 2025/0237251 A1
(43) Pub. Date: Jul. 24, 2025

(54) PLUG AND METHOD OF PLUGGING HOLES IN PLASTIC PANELS

(71) Applicant: SATELLITE INDUSTRIES, INC., Minneapolis, MN (US)

(72) Inventor: Kenneth V. SCHOMBURG, Plymouth, MN (US)

(21) Appl. No.: 18/791,065

(22) Filed: Jul. 31, 2024

Related U.S. Application Data
(60) Provisional application No. 63/624,710, filed on Jan. 24, 2024.

(51) Int. Cl. F16B 13/14

(52) U.S. Cl. CPC F16B 13/14

(57) ABSTRACT

Provided is a plug body that includes a conical head and a hex-shaped shank extending longitudinally rearward from the head. A transition portion can be formed between the head and the shank. The shank fits into a female hex receiver for a rotary tool or drill. The plug can be rotated at high speed with the head pressed slightly into a hole to be plugged in a wall. A few seconds of rotation at high speed causes the plug and the plastic wall to melt together. Then the rotation is stopped and the plug is held still while the plastic cools, completing the plastic welding process. The protruding portions of the plug can then be trimmed flush with the wall's inner and outer surfaces.

### PRIORITY

This application claims the priority benefit of U.S. Provisional Application No. 63/624,710, filed on Jan. 24, 2024, which is hereby incorporated herein by reference in its entirety.

### FIELD

The present invention relates generally to plugs for holes in plastic panels and methods for plugging holes in plastic panels.

### BACKGROUND

Wall panels and dividers are commonly formed of a plastic sheet of material. The sheet can be flat or formed with patterns or shapes. In one non-limiting example, a portable restroom structure is formed of four upright wall panels atop a pallet or base. One of the panels can comprise a door. A roof is then fastened atop the walls to form the enclosed restroom.

A variety of reasons may cause a hole to be formed in a plastic wall panel. For example, intentional or unintentional punctures can be caused by projectiles or tools. Manufacturing or installation mistakes may occur. The panel could also be formed with extra holes that may not be needed in certain applications. Regardless of the cause, a hole in a wall panel can present problems, such as a lack of privacy, ingress of water or debris or insects and/or potentially a means for illegally gaining entry to a locked enclosure. Moreover, an enclosure with holes in its walls is unsightly.

Replacing wall panels due to holes is expensive and may not be possible in some circumstances. Flat patches over the holes are unsightly and may not be possible depending on the contours of the panel. Tape is not a permanent repair and is unsightly as well. Therefore, there is a continuing need to provide a solution to repair holes in plastic wall panels.

### SUMMARY

The present invention provides a plug body that includes a conical head and a hex-shaped shank extending longitudinally rearward from the head. A transition portion can be formed between the head and the shank. The shank fits into a female hex receiver for a rotary tool or drill. The plug can be rotated at high speed with the head pressed slightly into a hole to be plugged in a wall. A few seconds of rotation at high speed causes the plug and the plastic wall to melt together. Then the rotation is stopped and the plug is held still while the plastic cools, completing the plastic welding process. The protruding portions of the plug can then be trimmed flush with the wall's inner and outer surfaces.

In one example embodiment, a plug for holes in plastic panels includes a singular body formed of a plastic material and elongated in a longitudinal direction. The singular body comprises a conical head portion and a hex-shaped shank portion extending longitudinally opposite of the head portion. A tip of the conical head portion faces longitudinally away from the hex-shaped shank portion.

A transition portion can be formed longitudinally between the conical head portion and the hex-shaped shank portion.

A diameter of the conical head portion can linearly increase in the longitudinal direction from the tip to a base of the conical head portion. A diameter of the conical head portion can linearly increase in the longitudinal direction from the tip towards the hex-shaped shank portion. A maximum diameter of the conical head portion is larger than a maximum diameter of the hex-shaped shank portion.

The tip can be rounded or pointed.

The hex-shaped shank portion can define a cross-sectional hexagonal shape. The cross-sectional hexagonal shape may be sized to engage a ¼ (quarter) inch female hex receiver. This hex shape provides a method for easily gripping the plug against the torque generated during the spinning and welding process. It also allows the easy insertion and removal of the plug from the installation tool bit. Any other shape for the shank could be used in other alternatives.

The transition portion or a base of the head portion can be configured to serve as a depth stop for the hex-shaped shank portion when the hex-shaped shank portion is inserted into a female hex driver.

The singular body can comprise Linear Low Density Polyethylene (LLDPE) or other plastic material or other materials as discussed herein below. The singular body can further comprise a colorant.

In another example, a method of plugging a hole in a plastic panel is provided. The method comprises inserting a hex-shaped shank end of a plastic plug into a female hex driver, inserting a tip of a tapered conical head of the plastic plug into the hole in the plastic panel, rotating the plastic plug while pressing the tapered conical head of the plastic plug into the hole until the plastic plug becomes welded to the plastic panel, removing the female hex driver from the hex-shaped shank end of the plastic plug after the plastic plug is welded to the plastic panel, and cutting off a portion of the plastic plug that protrudes beyond a plane of the plastic panel.

The hole in the plastic panel can be drilled out so that the hole has a uniform diameter prior to inserting the tip of the conical head of the plastic plug into the hole in the plastic panel.

The female hex driver can be part of a rotary tool or a drill.

The step of rotating the plastic plug while pressing the plastic plug into the hole until the plastic plug becomes welded to the plastic panel can be performed in approximately three seconds when using a rotary tool or a drill to spin the plastic plug.

The plastic plug can be pressed continuously into the hole for 15-20 seconds after the plastic plug becomes welded to the plastic panel and the step of rotating has stopped so that any melted plastic in the weld can cool and solidify.

The step of cutting off the portion of the plastic plug that protrudes beyond the plane of the plastic panel can include using a flush trim tool to trim off the portion of the plastic plug that protrudes beyond the plane of the plastic panel.

The step of rotating the plastic plug while pressing the tapered conical head of the plastic plug into the hole until the plastic plug becomes welded to the plastic panel can include rotating the plastic plug at a rotational speed of 20,000 to 30,000 rotations per minute. Other rotational speeds can also be used in alternative embodiments.

The plug can be formed of LLDPE or other plastic material or other materials as discussed herein below. The plug can be provided in a variety of different colors.

The above summary is not intended to limit the scope of the invention, or describe each embodiment, aspect, implementation, feature or advantage of the invention. The detailed technology and preferred embodiments for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 is a perspective view of a plug in accordance with certain embodiments.

FIG. 2 is another perspective view of a plug in accordance with certain embodiments.

FIG. 3 is a further perspective view of a plug in accordance with certain embodiments.

FIG. 4 is a rear end view of a plug in accordance with certain embodiments.

FIG. 5 is a front end view of a plug in accordance with certain embodiments.

FIGS. 6, 7, 8 and 9 are each orthogonal side views of a plug in accordance with certain embodiments.

FIG. 10 is an image of a plug and hex bit in accordance with certain embodiments.

FIG. 11 is an illustration of a wall plugging method in accordance with certain embodiments.

FIGS. 12 and 13 are images of wall plugging methods in accordance with certain embodiments.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the scope of the invention as defined by the appended claims.

### DETAILED DESCRIPTION

In the following descriptions, the present invention will be explained with reference to various exemplary embodiments. Nevertheless, these embodiments are not intended to limit the present invention to any specific example, environment, application, or particular implementation described herein. Therefore, descriptions of these example embodiments are only provided for purpose of illustration rather than to limit the present invention.

It should be recognized, however, that the dimensions, proportions, scale and configurations of components are merely example embodiments and can be varied unless specifically limited in a given claim. Thus, the dimensions, proportions, scale and configurations can be varied without departing from the scope of the invention except where explicitly limited by a given claim.

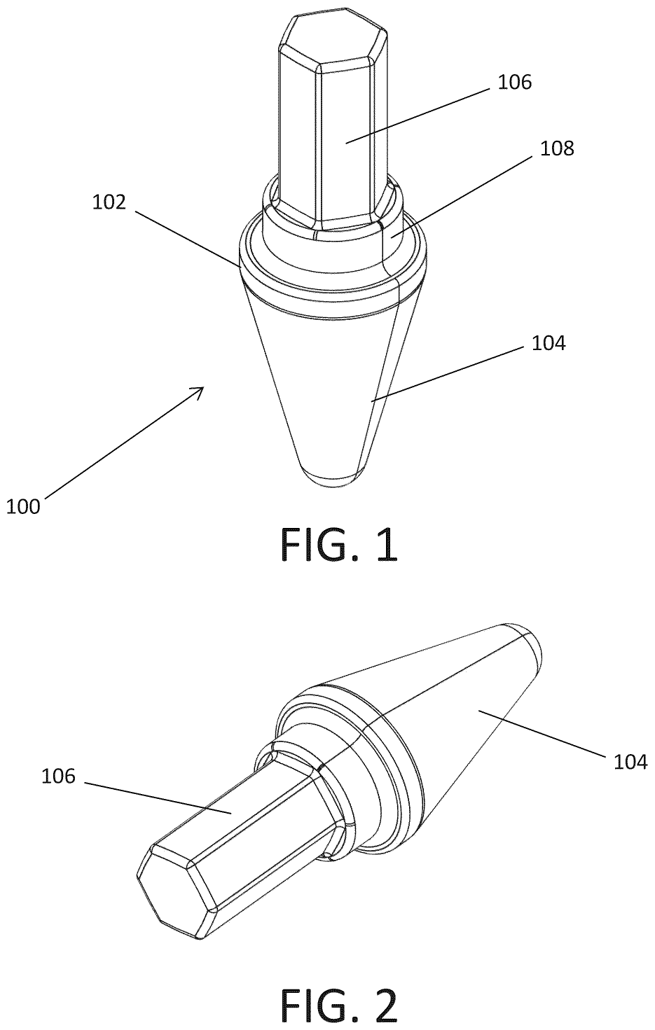

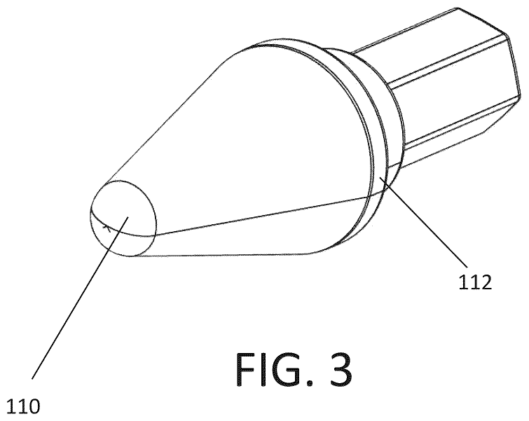

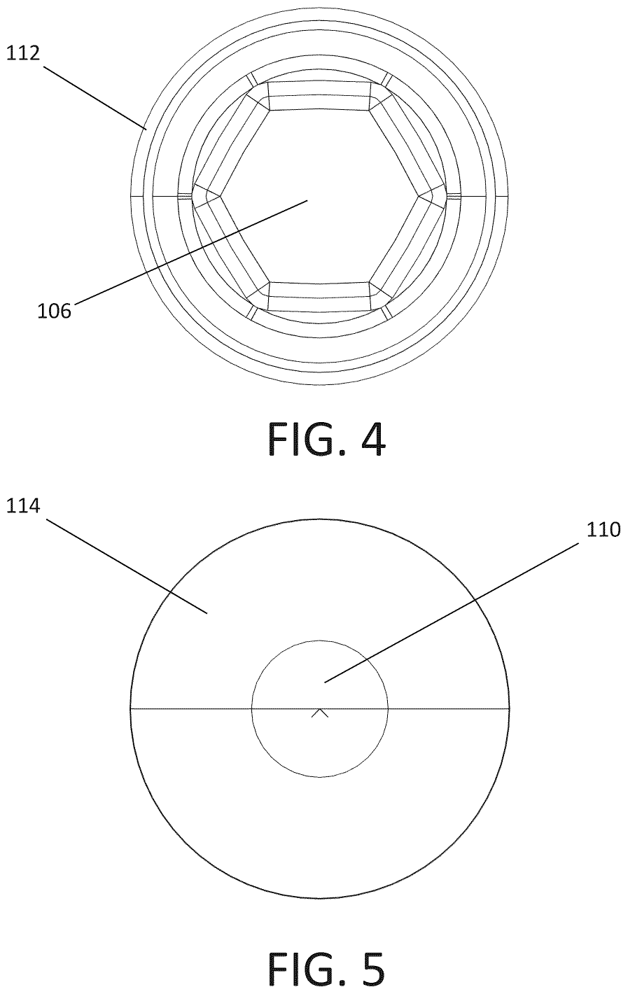

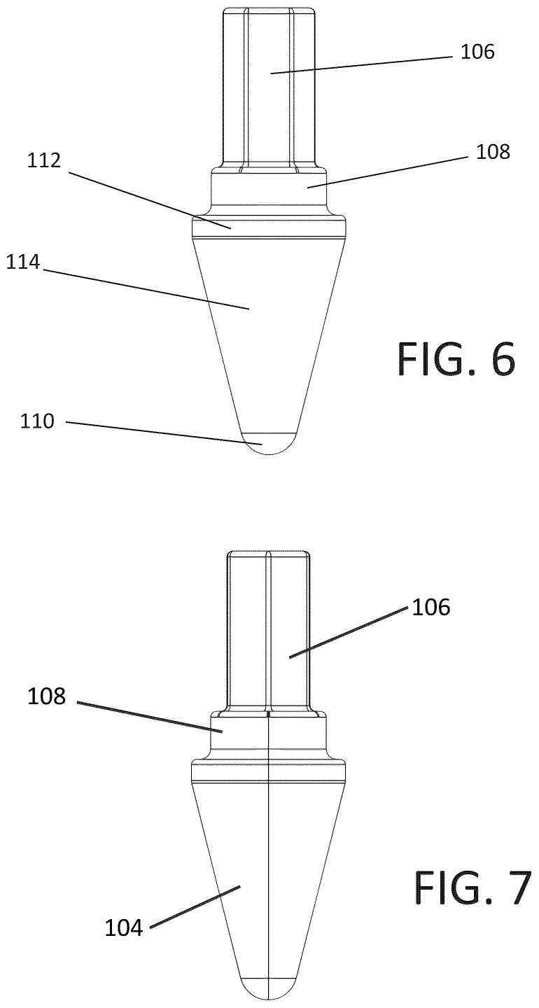

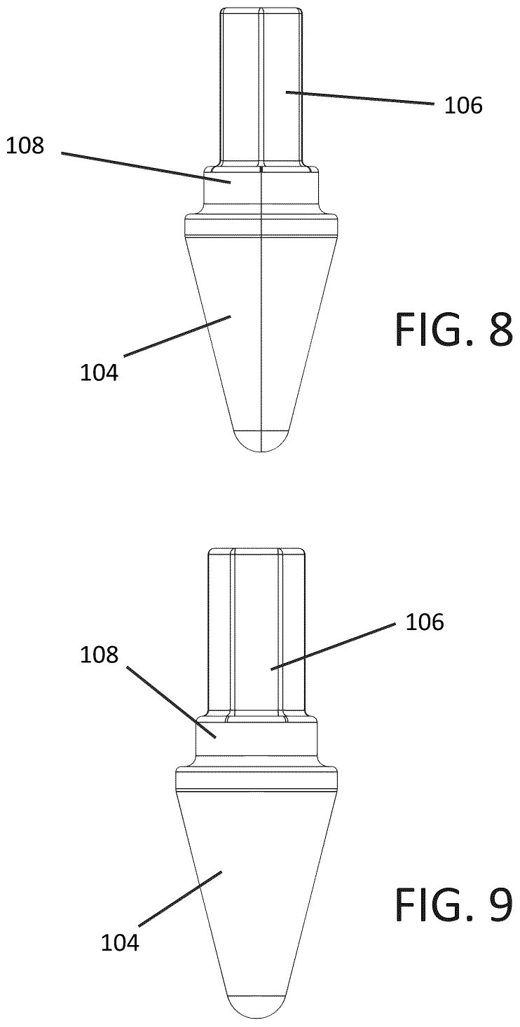

Referring to FIGS. 1-9, the plug 100 is illustrated in various views. The plug generally comprises a singular or unitary body 102 formed of a plastic material. A suitable material is Linear Low Density Polyethylene (LLDPE). LLDPE is particularly well suited for plugging holes in plastic sheet material because LLDPE has a relatively high tensile strength and impact and puncture resistance as compared to LDPE. LLDPE also has a favorable level of resistance to chemicals. It should be noted however, that other suitable materials, such as other grades of polyethylene or other thermoplastic materials may be employed in alternative embodiments.

The plug 100 is preferably formed via a molding operation, such as, but not limited to, injection molding. A colorant can be added to the material so that plugs can be formed in any desired color to match various wall panel colors.

The plug body 102 is elongated in a longitudinal direction and comprises a conical head or forward end 104 and a hex-shaped tail or shank 106 extending longitudinally rearward from the head. A transition portion 108 can be formed between the head 104 and shank 106.

The forwardmost extent or tip 110 of the head 104 defines a smallest diameter of the conical shape. The diameter of the head 104 linearly increases as the conical shape extends longitudinally rearward towards the shank 106 until it terminates at the base 112 where the maximum diameter is located. The tip 110 is shown to be rounded but can also be more sharply pointed or completely pointed. The diameter range of the outer conical surface 114 between the tip 110 and base 112 defines the range of hole diameters that the plug 100 can fill in a given plugging operation.

The shank 106 defines a longitudinally elongated hex key shape. In one example, the hex has a cross-sectional size to allow the shank 106 to engage a ¼ (quarter) inch female hex receiver such as commonly used with a rotary tool or drill. The shank 106 terminates on a forward end in the transitional portion 108 which has a diameter that exceeds the maximum diameter of the shank 106, but has a smaller diameter than that of the base 112 of the head 104. The transition portion 108 serves to define a depth stop for insertion of the shank 106 into a female hex receiver. Also, the transition portion 108 adds bending strength to the plug because there is a more gradual transition between the diameter of the shank 106 and the diameter of the base 112.

The hex shank 106 of the plug 100 provides a method to easily drive the plug 100 using a rotary tool. This eliminates the need for hand tools to tighten and loosen the engagement of each plug with the rotary tool as it is installed. Once a plug is installed, the hex receiver tool is simply pulled off of the hex shaft of the plug. The hex shape of the shank 106 also provides good resistance to turning inside the receiver bit as torque is applied during installation. The hex shape is just one example of possible cross-sectional shapes. Square, star, semicircular, other polygonal shapes and even complex or irregular shapes can also be employed.

In alternative embodiments, the transition portion 108 can be omitted from the plug body 102 such that the shank 106 and head 104 are immediately adjacent to one another along the longitudinal direction.

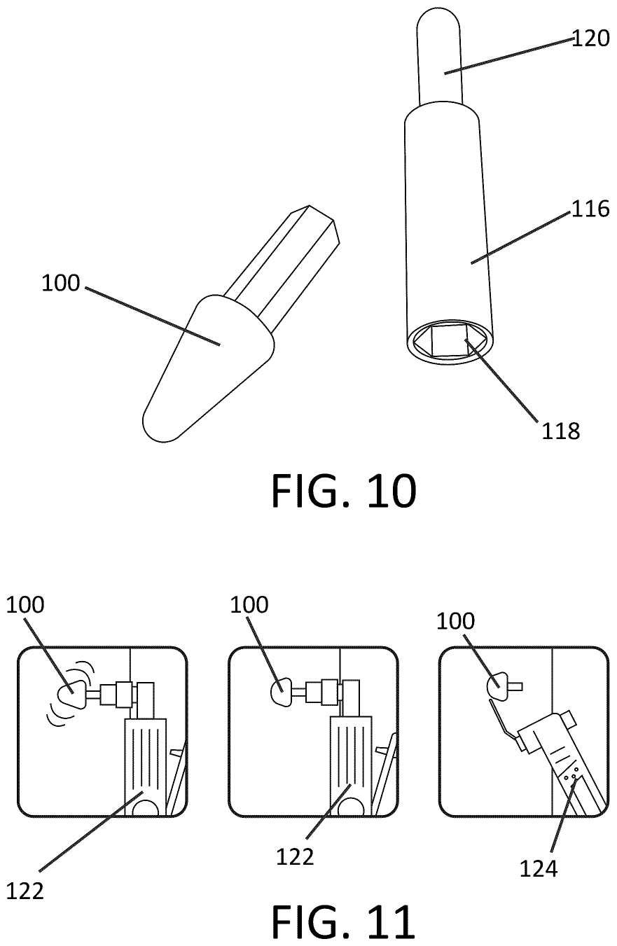

Referring to FIG. 10, a hex receiver bit 116 is shown. The receiver bit comprises a female hex receiver portion 118 on a forward end and a cylindrical shank portion 120 on the rearward end thereof. This hex receiver bit 116 serves as an adapter to allow the plug to be used with rotary tools that employ a standard drill chuck or collet. The hex receiver bit 116 can be packaged with one or more plugs 100 in a kit.

Referring to FIG. 11, steps of a hole repair method will now be described. First, it should be ensured that the hole diameter to be plugged does not exceed the maximum diameter of the outer conical surface 114 of the head 104 of the plug 100. Then, if the hole to be repaired is not a uniform round diameter, it can be drilled out prior to plugging in order to achieve uniform circular diameter for maximum plugging effectiveness.

Once the hole is ready for plugging, the shank 106 of the plug 100 is inserted into a female hex receiver of a rotary tool 122 or drill. The tip of the plug's head 104 is inserted through the hole to be plugged until the conical surface 114 engages the circumferential inner surface of the hole. Then, while applying continuous light pressure on the head 104 in a direction towards the hole, the rotary tool 122 or drill is activated to spin at a rapid speed for approximately three seconds. After the three seconds, the rotary tool 122 is stopped while the light pressure is still maintained for another 15-20 seconds to allow the melted plastic to cool and solidify. Then the tool 122 can be withdrawn and the shank 104 of the plug will release from the hex receiver and stay in place since it is now welded to the wall panel. A flush trim tool 124 is then used to remove the portion of the plug protruding from each side of the wall. The result is that the wall panel is now plugged and a smooth outer surface finish is achieved. If a smooth surface is not needed, hand side cutters or a similar tool could be used to quickly cut the protruding plug pieces.

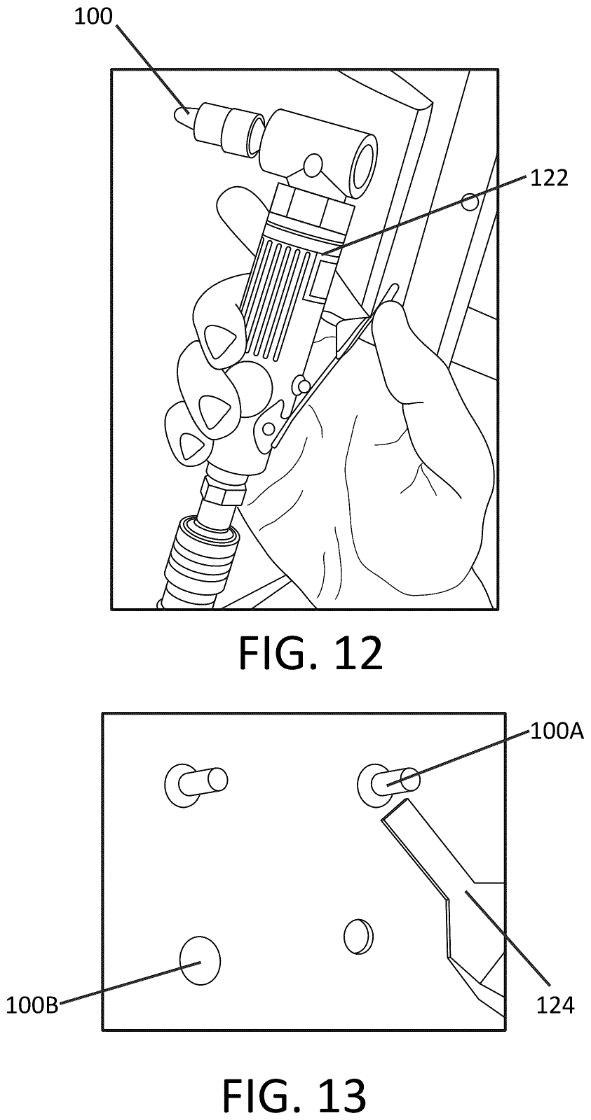

FIG. 12 illustrates a rotary tool with a plug 100 inserted through a hole in a wall panel.

FIG. 13 illustrates several plugged holes in a wall panel and one hole that has not yet been plugged. A flush trim tool 124 is shown in position to trim one of the plugs 100A. Another of the plugs 100B shows the resulting flush trimmed plug after trimming using the flush trim tool 124.

Note that the present plug device, system and plugging method can be used with or applied to a wide variety of walls that are formed of plastic material. For example, the present invention can be used to plug holes in tanks, barrels, plastic body panels such as for vehicles and boats, and other items with a plastic wall portion. The same general method can be applied to panels made of metal, such as aluminum or steel, using plugs made of compatible metals.

Benefits and features of certain embodiments include one or more of the following:
a. The hex shaft or shank 106 on the plug 100 allows the easy insertion into a female hex driver tool and provides the necessary grip for driving the plug 100 without slipping. It also allows easy removal from the driver tool once the plastic welding process is complete. Other shapes could also be used, including a round shaft. A locking collet can be provided if a round shaft were employed.
b. The tapered cone shape of the head 104 allows the plug 100 to fill many sizes of holes, and odd-shaped holes. Different cone sizes can be provided to plug or fill larger and smaller holes.
c. The plug 100 is ideally used to patch or plug polyethylene parts. However, a similar plug can be employed to patch almost any thermoplastic, such as ABS or nylon, and possibly even metal materials.
d. The plug's configuration allows the use of basic, inexpensive tools for installation. A rotary tool, or a pneumatic or electric die grinder work well for installation because they reach high rotational speeds of 20,000-30,000 rotations per minute. The plug installation process can easily be performed at remote sites using such tools. Other rotational speeds can also be used in alternative embodiments.
e. Once welded in place, the plug 100 will protrude from both sides of the patched panel. This protrusion may be cut off flush for aesthetic purposes. Hand cutters can be used. An electric oscillating cutting tool also works well to cut through the thicker diameter of the plug and allows a fairly flush cut.
f. In many portable restrooms, rivets are used extensively for assembling toilets and mounting accessories. Often the assembler will drill a rivet hole in a wrong location and that may require the replacement of the entire side panel, which is very expensive. Customers do not want holes in their brand new toilet. Users of the restrooms also do not want to use restrooms with holes in the walls. The present plug and plugging method allow for the repair of unwanted holes of a variety of sizes and eliminates the need to replace a large, expensive part.
g. The plugs can be molded in various colors to match the plastic being patched or plugged.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products. Moreover, features or aspects of various example embodiments may be mixed and matched (even if such combination is not explicitly described herein) without departing from the scope of the invention.

What is claimed is:

1. A plug for holes in plastic panels, the plug comprising:
a singular body formed of a plastic material, the body elongated in a longitudinal direction, the singular body comprising:
a conical head portion; and
a hex-shaped shank portion extending longitudinally opposite of the head portion, wherein a tip of the conical head portion faces longitudinally away from the hex-shaped shank portion.

2. The plug of claim 1, wherein the singular body further comprises a transition portion formed longitudinally between the conical head portion and the hex-shaped shank portion.

3. The plug of claim 1, wherein a diameter of the conical head portion linearly increases in the longitudinal direction from the tip to a base of the conical head portion.

4. The plug of claim 1, wherein a diameter of the conical head portion linearly increases in the longitudinal direction from the tip towards the hex-shaped shank portion.

5. The plug of claim 1, wherein the tip is rounded.

6. The plug of claim 1, wherein the tip is pointed.

7. The plug of claim 1, wherein the hex-shaped shank portion defines a cross-sectional hexagonal shape.

8. The plug of claim 7, wherein the cross-sectional hexagonal shape is sized to engage a ¼ (quarter) inch female hex receiver.

9. The plug of claim 7, wherein a maximum diameter of the conical head portion is larger than a maximum diameter of the hex-shaped shank portion.

10. The plug of claim 1, wherein the singular body further comprises a transition portion formed longitudinally between the conical head portion and the hex-shaped shank portion, and wherein the transition portion is configured to serve as a depth stop for the hex-shaped shank portion when the hex-shaped shank portion is inserted into a female hex driver.

11. The plug of claim 1, wherein the singular body comprises Linear Low Density Polyethylene (LLDPE).

12. The plug of claim 11, wherein the singular body further comprises a colorant.

13. A method of plugging a hole in a plastic panel, the method comprising:
inserting a hex-shaped shank end of a plastic plug into a female hex driver;
inserting a tip of a tapered conical head of the plastic plug into the hole in the plastic panel;
rotating the plastic plug while pressing the tapered conical head of the plastic plug into the hole until the plastic plug becomes welded to the plastic panel;
removing the female hex driver from the hex-shaped shank end of the plastic plug after the plastic plug is welded to the plastic panel; and
cutting off a portion of the plastic plug that protrudes beyond a plane of the plastic panel.

14. The method of claim 13, further comprising drilling out the hole in the plastic panel so that the hole has a uniform diameter prior to inserting the tip of the conical head of the plastic plug into the hole in the plastic panel.

15. The method of claim 13, wherein the female hex driver is installed in or is a part of a rotary tool or a drill.

16. The method of claim 13, wherein the step of rotating the plastic plug while pressing the plastic plug into the hole until the plastic plug becomes welded to the plastic panel is performed for approximately three seconds when using a rotary tool or a drill to spin the plastic plug.

17. The method of claim 13, further comprising continuing to press the plastic plug into the hole for 15-20 seconds after the plastic plug becomes welded to the plastic panel and the step of rotating has stopped so that any melted plastic in the weld can cool and solidify.

18. The method of claim 13, wherein the step of cutting off the portion of the plastic plug that protrudes beyond the plane of the plastic panel includes using a flush trim tool to trim off the portion of the plastic plug that protrudes beyond the plane of the plastic panel.

19. The method of claim 13, wherein the step of rotating the plastic plug while pressing the tapered conical head of the plastic plug into the hole until the plastic plug becomes welded to the plastic panel includes rotating the plastic plug at a rotational speed of 20,000 to 30,000 rotations per minute.

20. The method of claim 13, further comprising forming the plastic plug from Linear Low Density Polyethylene (LLDPE).
